(19) United States
(12) Patent Application Publication
(10) Pub. No.: US 2017/0169486 A1
(43) Pub. Date: Jun. 15, 2017

(54) METHOD AND APPARATUS FOR COLLECTING FEEDBACK AND/OR RATING INFORMATION

(71) Applicant: B-SM@RK LIMITED, Dublin (IE)

(72) Inventors: Nicola Farronato, Dublin (IE); Paolo Maria Panizza, Bassano del Grappa (IT)

(21) Appl. No.: 15/323,084

(22) PCT Filed: Jul. 3, 2014
(86) PCT No.: PCT/EP2014/064231

§ 371 Date: Dec. 29, 2016

(51) Int. Cl. G06Q 30/02

(52) U.S. Cl. CPC G06Q 30/0282

(57) ABSTRACT

A method and apparatus can be configured to display a plurality of zones to a user. The plurality of zones is displayed during a process flow. Each zone of the plurality of zones corresponds to a different rating related to the process flow. The process flow includes a plurality of steps to progress through. The method also includes determining a selected zone that is selected by the user. The method also includes progressing to a next step of the process flow upon determining the selected zone. The plurality of zones are configured to allow the user to perform a dual action that comprises providing a rating related to the process flow and progressing to the next step of the process flow by performing a singular step of selecting the selected zone. The method also includes collecting the rating provided by the user.

### BACKGROUND

Field

Embodiments of the invention relate to collecting feedback and/or rating information from a user without adding any new steps into a process.

Description of the Related Art

Customer satisfaction is generally understood as a measure of whether the goods and/or services of a company fail to meet, meet, or exceed the expectations of customers. As marketplaces become more competitive, companies have been increasingly interested in accurately gauging customer satisfaction. In order to accurately gauge customer satisfaction, companies may need their customers to provide accurate and enough feedback.

### SUMMARY

According to a first embodiment, a method may include displaying a plurality of zones to a user. The plurality of zones is displayed during a process flow. Each zone of the plurality of zones corresponds to a different rating related to the process flow. The process flow includes a plurality of steps to progress through. The method may include determining a selected zone that is selected by the user. The method may also include progressing to a next step of the process flow upon determining the selected zone. The plurality of zones are configured to allow the user to perform a dual action that includes providing a rating related to the process flow and progressing to the next step of the process flow by performing a singular step of selecting the selected zone. The method may also include collecting the rating provided by the user.

In the method of the first embodiment, the displaying the plurality of zones includes displaying a multizone button, and a portion of the multizone button corresponds to a neutral rating or does not correspond to any rating.

In the method of the first embodiment, the displaying the plurality of zones includes displaying an emotional-rose button.

In the method of the first embodiment, the displaying the multizone button includes displaying a multizone button that functions as a navigation button, and the navigation button navigates through displayed content.

In the method of the first embodiment, the displaying the plurality of zones includes displaying the plurality of zones on different portions of a door.

In the method of the first embodiment, the displaying the plurality of zones includes displaying the plurality of zones on a keypad of a point-of-sale device.

In the method of the first embodiment, the displaying the plurality of zones includes providing a plurality of gates, and each zone of the plurality of zones corresponds to a gate of the plurality of gates. The determining the selected zone that is selected by the user includes determining which gate the user moves through.

In the method of the first embodiment, the displaying the plurality of zones includes displaying the zones on a vending machine. The collecting the rating includes collecting a rating of a purchasing experience with the vending machine or a rating of a product purchased from the vending machine.

In the method of the first embodiment, the displaying the plurality of zones to the user includes displaying the zones as at least one of a gradient or an affect pad.

According to a second embodiment, an apparatus includes at least one processor. The apparatus also includes at least one memory including computer program code. The at least one memory and the computer program code may be configured, with the at least one processor, to cause the apparatus at least to display a plurality of zones to a user. The plurality of zones is displayed during a process flow. Each zone of the plurality of zones corresponds to a different rating related to the process flow. The process flow includes a plurality of steps to progress through. The apparatus may also be caused to determine a selected zone that is selected by the user. The apparatus may also be caused to progress to a next step of the process flow upon determining the selected zone. The plurality of zones are configured to allow the user to perform a dual action that includes providing a rating related to the process flow and progressing to the next step of the process flow by performing a singular step of selecting the selected zone. The apparatus may also be caused to collect the rating provided by the user.

In the apparatus of the second embodiment, the displaying the plurality of zones includes displaying a multizone button, and a center portion of the multizone button corresponds to a neutral rating or does not correspond to any rating.

In the apparatus of the second embodiment, the displaying the plurality of zones includes displaying an emotional-rose button.

In the apparatus of the second embodiment, the displaying the multizone button includes displaying a multizone button that functions as a navigation button, and the navigation button navigates through displayed content.

In the apparatus of the second embodiment, the displaying the plurality of zones includes displaying the plurality of zones on different portions of a door.

In the apparatus of the second embodiment, the displaying the plurality of zones includes displaying the plurality of zones on a keypad of a point-of-sale device.

In the apparatus of the second embodiment, the displaying the plurality of zones includes providing a plurality of gates, and each zone of the plurality of zones corresponds to a gate of the plurality of gates, and the determining the selected zone that is selected by the user includes determining which gate the user moves through.

In the apparatus of the second embodiment, the displaying the plurality of zones includes displaying the zones on a vending machine. The collecting the rating includes collecting a rating of a purchasing experience with the vending machine or a rating of a product purchased from the vending machine.

In the apparatus of the second embodiment, the displaying the plurality of zones to the user includes displaying the zones as at least one of a gradient or an affect pad.

According to a third embodiment, a computer program product may be embodied on a non-transitory computer readable medium. The computer program product may be configured to control a processor to perform a process including displaying a plurality of zones to a user. The plurality of zones is displayed during a process flow. Each zone of the plurality of zones corresponds to a different rating related to the process flow. The process flow includes a plurality of steps to progress through. The process may also include determining a selected zone that is selected by the user. The process may also include progressing to a next step of the process flow upon determining the selected zone. The plurality of zones are configured to allow the user to perform a dual action that includes providing a rating related to the process flow and progressing to the next step of the process flow by performing a singular step of selecting the selected zone. The process may also include collecting the rating provided by the user.

In the computer program product of the third embodiment, the displaying the plurality of zones includes displaying a multizone button, and a center portion of the multizone button corresponds to a neutral rating or does not correspond to any rating.

In the computer program product of the third embodiment, the displaying the plurality of zones includes displaying an emotional-rose button.

In the computer program product of the third embodiment, the displaying the multizone button includes displaying a multizone button that functions as a navigation button, and the navigation button navigates through displayed content.

In the computer program product of the third embodiment, the displaying the plurality of zones includes displaying the plurality of zones on different portions of a door.

In the computer program product of the third embodiment, the displaying the plurality of zones includes displaying the plurality of zones on a keypad of a point-of-sale device.

In the computer program product of the third embodiment, the displaying the plurality of zones includes providing a plurality of gates, and each zone of the plurality of zones corresponds to a gate of the plurality of gates, and the determining the selected zone that is selected by the user includes determining which gate the user moves through.

In the computer program product of the third embodiment, the displaying the plurality of zones includes displaying the zones on a vending machine. The collecting the rating includes collecting a rating of a purchasing experience with the vending machine or a rating of a product purchased from the vending machine.

In the computer program product of the third embodiment, the displaying the plurality of zones to the user includes displaying the zones as at least one of a gradient or an affect pad.

### BRIEF DESCRIPTION OF THE DRAWINGS

For proper understanding of the invention, reference should be made to the accompanying drawings, wherein:

FIG. 1 illustrates a user interface that uses a multizone button in conjunction with a comment text box in accordance with one embodiment.

FIG. 2 illustrates a user interface that uses a multizone button in conjunction with means for receiving qualitative input in accordance with one embodiment.

FIG. 3 illustrates a user interface that uses a typical posting button in conjunction with a comment text box in accordance with the previous approaches.

FIG. 4 illustrates a user interface that uses a multizone button in conjunction with a comment text box in accordance with one embodiment.

FIG. 5 illustrates a user interface that uses another typical posting button in conjunction with a sending of a short message in accordance with the previous approaches.

FIG. 6 illustrates a user interface that uses a multizone button in conjunction with the sending of a short message in accordance with one embodiment.

FIG. 7 illustrates a user interface that uses a multizone button in conjunction with sharing content in accordance with one embodiment.

FIG. 8 illustrates a user interface that uses multizone buttons in conjunction with navigation buttons in accordance with one embodiment.

FIG. 9 illustrates a user interface that uses typical buttons for adding products to a cart and for purchasing products in accordance with the previous approaches.

FIG. 10 illustrates a user device that uses a gradient/continuum to receive feedback/rating in accordance with one embodiment.

FIG. 11 illustrates a user device that uses multizone buttons to complete an electronic-commerce transaction in accordance with one embodiment.

FIG. 12 illustrates a zoned feedback-rating/action button in accordance with one embodiment.

FIG. 13 illustrates a 2-dimensional affective-gradient feedback-rating/action button in accordance with one embodiment.

FIG. 14 illustrates a multizone door handle in accordance with one embodiment.

FIG. 15 illustrates implementing a feedback-rating/action button on a point-of-sale device in accordance with one embodiment.

FIG. 16 illustrates a flow diagram of a method according to one embodiment.

FIG. 17 illustrates an apparatus in accordance with one embodiment.

FIG. 18 illustrates an apparatus in accordance with another embodiment.

FIG. 19 illustrates an apparatus in accordance with another embodiment.

### DETAILED DESCRIPTION

Interactive webpages may contain elements that can receive user actions. By receiving user actions, the elements can allow a user to control a process/flow of displaying information. For example, the elements may be elements that correspond to functions such as “previous,” “next,” “play,” “pause,” and “stop,” etc. In addition to receiving user actions to control a process/flow, the elements may also receive an explicit feedback/rating from the user.

In the previous approaches for receiving explicit feedback/rating, users typically post ratings, provide comments, and/or indicate stars which correspond to their feedback. In the previous approaches, users may perform a “like” action, and/or indicate a “thumb up” or “thumb down,” for example. In other words, with the previous approaches, users would need to provide feedback/rating by performing a distinct action/step that is separate from the user action to control a process/flow (where the action for controlling the process/flow may include the posting of a comment, the completing of a commercial transaction, for example).

Specifically, according to the previous approaches, the users would need to specifically provide a feedback/rating apart from performing actions to control the corresponding process/flow, regardless of whether the rating is an overall rating, qualitative rating, and/or affective rating. In the previous approaches, the user may need to interact with a stand-alone element that is devoted entirely to receiving feedback. For example, the stand-alone option of providing feedback that is entirely devoted to providing feedback may be an option that receives a “like,” “thumbs up,” and/or “thumbs/down.”

In the previous approaches, providing feedback may be an optional/added step. Therefore, at least two steps are needed to accomplish: (1) a first main function of controlling a process/flow, and (2) a secondary function of providing feedback/rating relating to the main function. Because providing the feedback/rating may merely be an optional/added step, users may decide to not provide ratings, or the user may be too lazy to provide a rating. As such, the previous approaches may experience a deficiency in feedback/ratings from users.

In view of the difficulties of the previous approaches, embodiments of the present invention are directed to a method of collecting feedback/rating where the collecting is in a mandatory path of the main action that controls the process/flow. The collecting of feedback/ratings is achieved without adding any new steps and/or delay into the process/flow.

In one embodiment, the main action of controlling a process/flow may include entering information in a survey and/or entering information within a comment text box. The survey may request the user to select among a plurality of options (such a survey may be referred to as an “N-options survey”). Once a selection is entered in the N-options survey or information is entered within the comment text box, the user may submit the information by entering the information by using a “post” or “submit” button (which may be considered to be “entering means.”)

Embodiments of the present invention can use an entering means that comprises a multizone button. The multizone button can receive feedback. As such, the multizone button can serve a dual purpose of allowing the user to enter information, as well as receiving feedback/rating information. The multizone button presents the user with a plurality of selectable zones. The number of selectable zones can be as few as two. Each selectable zone can correspond to a different feedback/rating that may be provided by the user. For example, in one embodiment, the entering means can be replaced with a reduced version of an emotional rose. An emotional rose can comprise a plurality of zones which appear as petals, where each zone corresponds to a different rating/emotion. Each petal of the emotional rose, upon being selected by a user, can be used to provide a different feedback/rating. The area of the multizone button that is most-likely to be touched can correspond to a neutral feedback/rating. Further, the number of pedals/zones can be just two or three pedals/zones.

Although certain multizone buttons (such as an emotional rose) may configure a center portion as corresponding to a neutral feedback/rating or as corresponding to no feedback/rating, other multizone buttons may use other portions to correspond to having neutral feedback/no feedback. Other multizone buttons may designate a portion that is most-likely to be touched as corresponding to having neutral feedback/no feedback. Any portion of a multizone button may be designated as corresponding to neutral feedback/no feedback.

Although the plurality of zones for certain multizone buttons (like the emotional rose) may be distinct zones that are clearly delineated from one another, the plurality of zones for other multizone buttons may be less distinct. For example, other multizone buttons may display zones in accordance with a gradient, as described in more detail below. Other multizone buttons may display zones in accordance with an affect pad, as described in more detail below.

Further, although the plurality of zones for certain multizone buttons (like the emotional rose) may be adjacent/adjoining to one another, the plurality of zones for other multizone buttons may not be adjacent nor adjoining relative to one another.

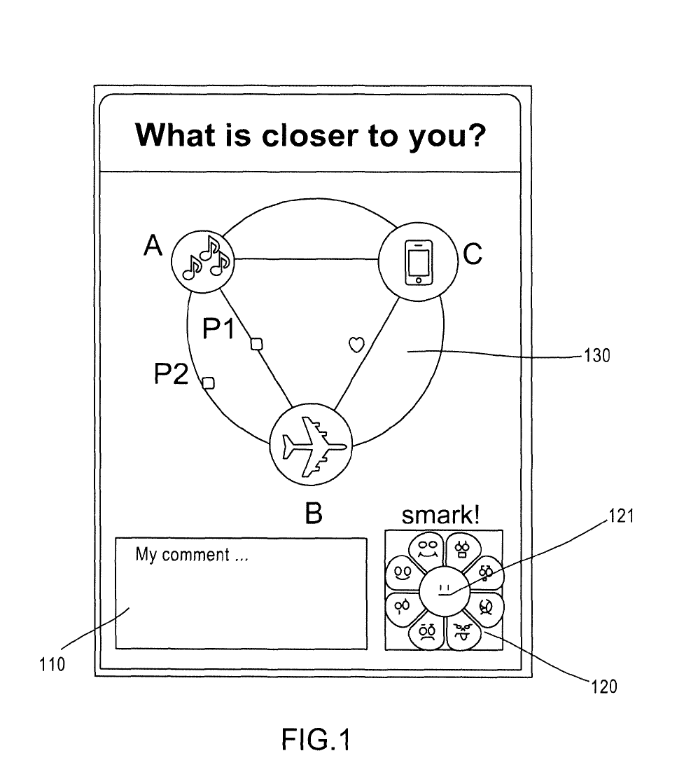

FIG. 1 illustrates a user interface that uses a multizone button in conjunction with a comment text box in accordance with one embodiment. A user may type content within comment text box 110. A user may also select a touch point in area 130 to reflect the user's interests. The user interface may include a multizone button such as emotional-rose 120. As described above, a user interacts with emotional rose 120 by selecting an emotion (by selecting a petal) that corresponds to a feedback/rating that the user wishes to provide. As a zone of the multizone button is selected, the multizone button performs the dual purpose of receiving feedback/rating, and submitting the typed comment, without requiring the user to perform a two-step process of a first step of submitting the content and separately submitting feedback/rating information with another distinct step. The center 121 of emotional rose 120 can correspond to a neutral rating or a lack of rating. However, as described above, the center 121 may also correspond to a non-neutral rating.

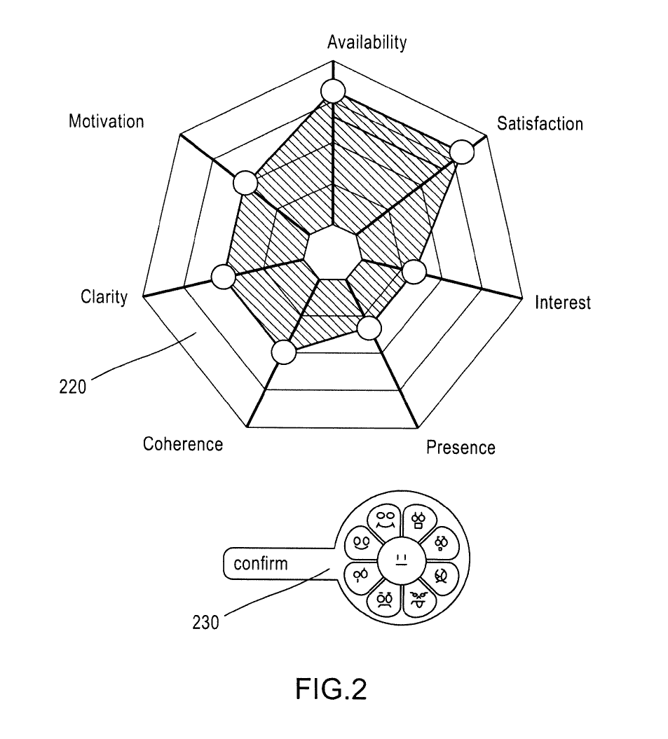

FIG. 2 illustrates a user interface that uses a multizone button in conjunction with means for receiving qualitative input in accordance with one embodiment. A user may also select a touch point in area 220 to transmit qualitative information to the system. Once a touch point is selected, the user can use multizone button 230 to perform the dual purpose of (1) confirming the selection, and (1) providing feedback/rating, at the same time.

In another embodiment, instead of replacing the entering means with a multizone button, the entering means can include a gradient/continuum that receives a touched point from the user. The touched point may correspond to a specific set of {x,y} coordinates. The received coordinates may correspond to a rating. Embodiments of the present invention can be driven by a back-end system to present the user with the most suitable (best guess) rating. Embodiments of the present invention can also present optional affective/satisfaction input main choices, according to context, user's characteristics, actions, and history, for example.

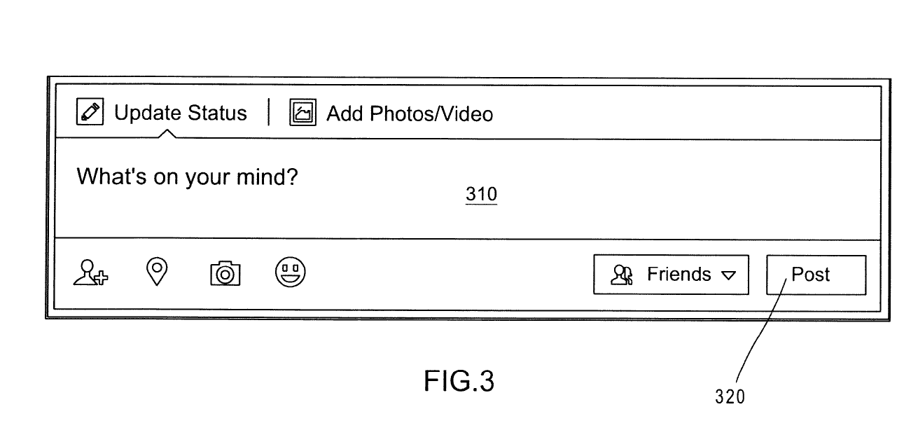

FIG. 3 illustrates using a typical posting button in conjunction with a comment text box in accordance with the previous approaches. A user can type content within the comment text box 310. According to the previous approaches, a user would submit/post the typed content using “post” button 320. However, post button 320 would merely submit/post the typed content without providing any feedback/rating information.

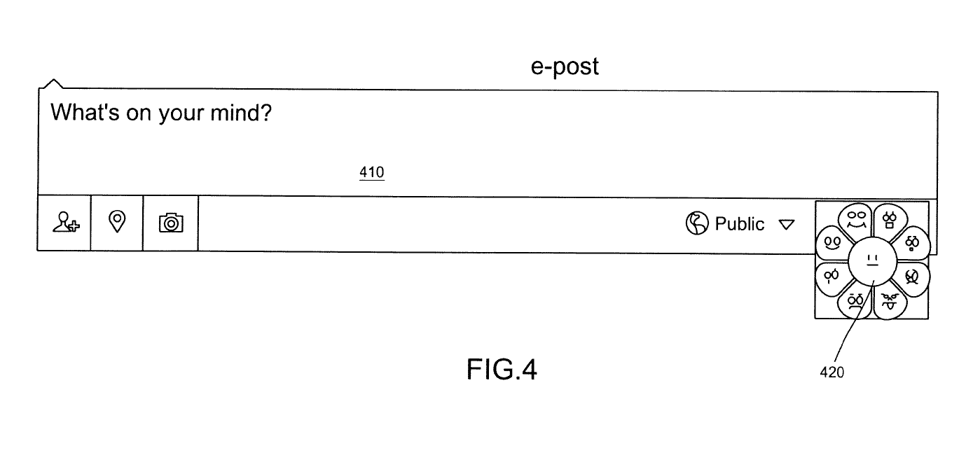

In contrast with the previous approach illustrated in FIG. 3, one embodiment of the invention performs the dual role of (1) allowing a user to submit/post the typed content as well as (2) receive feedback/rating information from the user at the same time. FIG. 4 illustrates using a multizone button in conjunction with a comment text box in accordance with one embodiment.

As illustrated in FIG. 4, a user may first type text in a comment text box 410. The user may then submit/post the typed content as well as provide feedback/rating information at the same time using multizone button 420. As such, the user may provide the text and tag the entered text with a rating/feedback at the same time, as opposed to typing text, entering the text, selecting a tag corresponding to feedback/rating, and entering the tag. In other words, with this embodiment, a rating/feedback tag may be embedded in the entering means, forming a feedback-rating/action button (such as the previously described multizone button, for example). The feedback-rating/action button can generally be considered to be a means for performing the dual role of (1) allowing a user to submit/post the information/content as well as (2) provide feedback/rating information at the same time. Although FIG. 4 illustrates using an emotional rose as the multizone button, other types of multizone buttons may be used in place of the emotional rose.

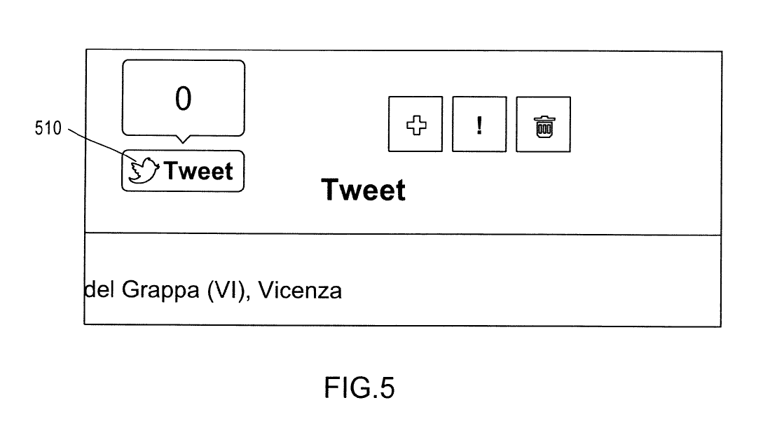

With embodiments of the present invention, the feedback-rating/action button may be used in a plurality of standalone actions, such as in Facebook™ (as shown above) and Twitter™, for example. FIG. 5 illustrates using another typical posting button in conjunction with the sending of a short message (such as a twitter message) in accordance with the previous approaches. Referring to FIG. 5, once a user types a twitter message, the user will post the twitter message by using the “tweet” button 510. However, with the previous approaches, tweet button 510 is merely used to post the twitter message, without providing any feedback/rating information. However, in contrast to the previous approach illustrated by FIG. 5, embodiments of the present invention can allow a user to post the twitter message and to provide feedback/rating at the same time.

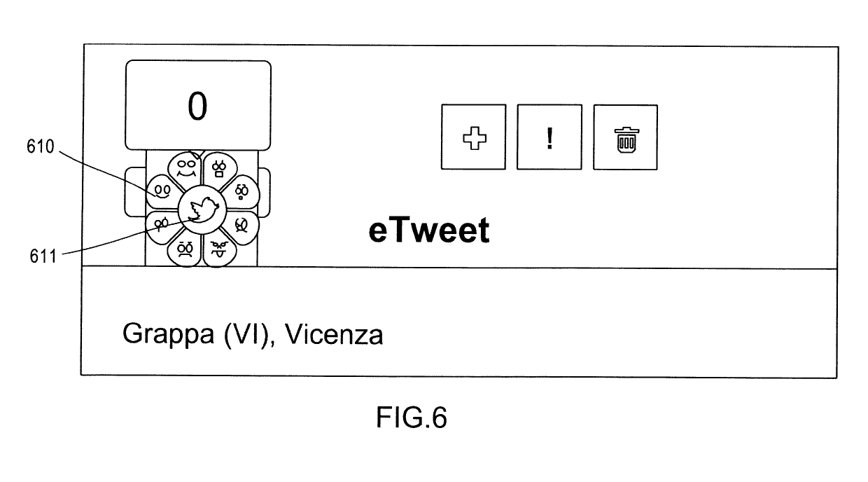

FIG. 6 illustrates a user interface that uses multizone button in conjunction with the sending of a short message in accordance with one embodiment. In contrast to the previous approach of sending a short message shown by FIG. 5, by using the user interface of FIG. 6, the user may then submit/post the short message as well as provide feedback/rating information at the same time, with a single action, using multizone button 610. Multizone button 610 may also have a center portion 611 that corresponds to a neutral rating or a lack of rating. Although FIG. 6 illustrates using an emotional rose as the multizone button, other types of multizone buttons may be used in place of the emotional rose.

In other words, with Twitter™, a button for receiving a feedback/rating may replace the normal entering means (i.e., the normal enter/submit button of Twitter™). Further, in general, when the user uses a comment box, the user may use shortcut key combinations, where pressing the <Enter> key submits the comment, while pressing <Shift-Enter> will move the cursor to a new line. Embodiments of the present invention may provide other shortcut key combinations to implement the functions of the above-described feedback-rating/action button. For example, in embodiments of the present invention, a user may use a shortcut key combination corresponding to <Ctrl-Enter> to perform the dual action of both (1) providing a negative feedback/rating, and (2) posting the text, at the same time. Further, in embodiments of the present invention, a user may press <Enter> to perform (1) providing a neutral feedback/rating, and (2) posting the text. Further, a user may press <Alt+Enter> to perform (1) providing a positive feedback/rating, and (2) posting the text. Other embodiments of the present invention may use other combinations of keys to provide the feedback/rating. In view of the above, embodiments of the present invention may allow a user to (1) enter their comment/text, and (2) providing feedback/rating, without requiring the user to perform further steps or unusual procedures.

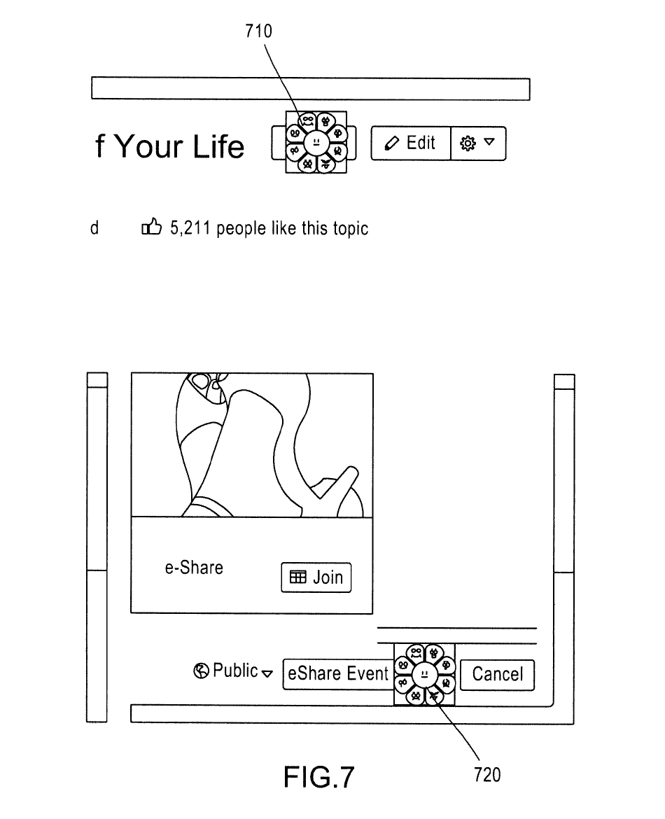

FIG. 7 illustrates an interface that uses a multizone button in conjunction with sharing content in accordance with one embodiment. A user may use multizone buttons 710 and 720 to share an event, picture, or any other content to others. Similar to the embodiments described above, the multizone buttons will allow a user to both share the desired content as well as provide feedback/ratings, in one action, at the same time. Although FIG. 7 (and the following figures) illustrates using an emotional rose as the multizone button, other types of multizone buttons may be used in place of the emotional rose.

Further, as the user writes text in a comment text box, an embodiment of the present invention may perform a sentiment analysis on the written text, and embodiments of the present invention may suggest/preselect a feedback/rating for the written text. Therefore, with this embodiment, a user may post the comment and also provide feedback/rating by merely confirming the suggested feedback/rating by pressing a simple <Enter>.

In embodiments of the present invention, a means for saving/submitting entered information (such as a “save” button) can be replaced by the above-described feedback-rating/action button. A “like” button can be replaced by the above-described feedback-rating/action button. Further, a means for sharing entered information (such as a “share” button) can also be replaced by the feedback-rating/action button.

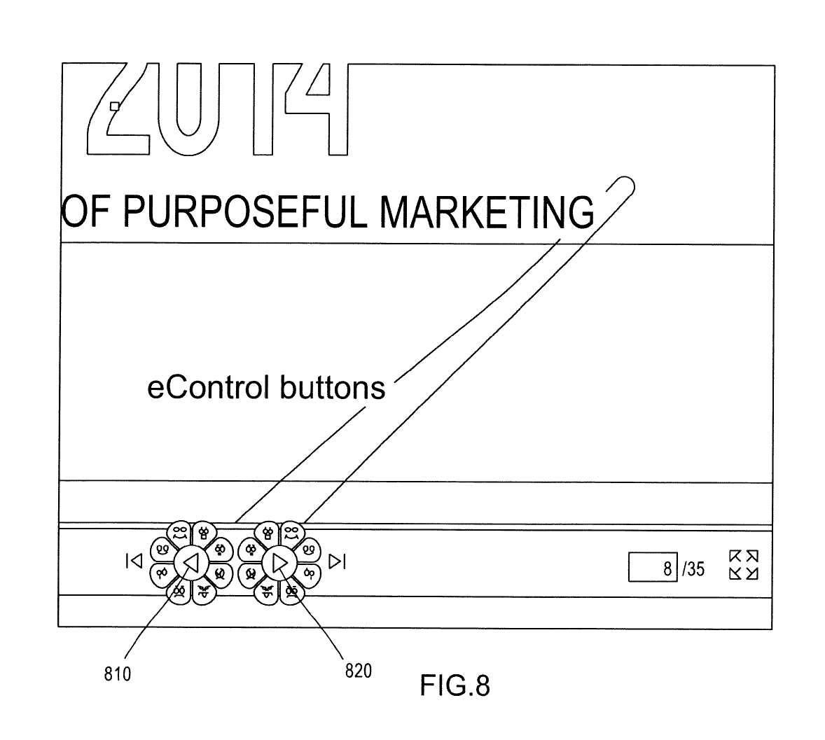

FIG. 8 illustrates a user interface that uses multizone buttons in conjunction with navigation buttons in accordance with one embodiment. Navigation buttons (such as a “play” button, “stop” button, “pause” button, “forward” button, “rewind” button, “next” button, “previous” button, for example) can also be replaced by the above-described feedback-rating/action button. Referring to FIG. 8, a user may use multizone button 810 to access previous content and to provide feedback/rating information. Similar to the embodiments discussed above, multizone button 810 allows a user to navigate through content and to provide feedback/input at the same time. In one embodiment, the center of multizone button 810 may allow a user to navigate through the content without providing any feedback/input. A user may use multizone button 820 to access next content. Navigation buttons may be buttons that are used in applications such as a slideshow, photo album, and/or a media player. The buttons may correspond to functions such as a “play” button, “stop” button, “record” button, and/or “add to playlist” button, for example. A navigation button may also be a button that performs the function of turning a page in a virtual reader. Virtual readers can include eReaders like Kindle™, for example.

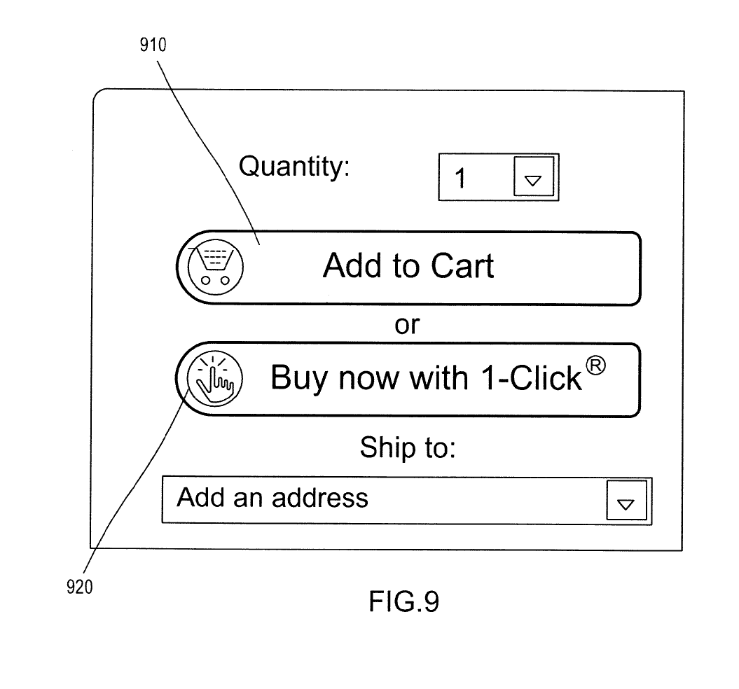

FIG. 9 illustrates a user interface that uses typical buttons for adding products to a electronic-commerce cart and for purchasing products in accordance with the previous approaches. In the previous approaches, users can add products to a cart by using button 910, and can complete the commercial transaction by using button 920. However, buttons 910 and 920 do not allow a customer to complete the transaction and to provide feedback/input at the same time.

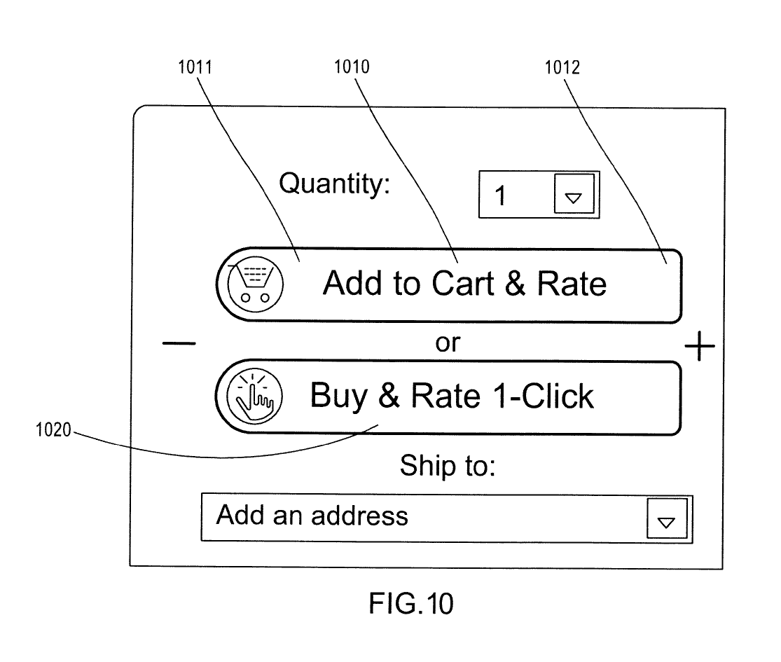

In contrast to the user interface of FIG. 9, FIG. 10 illustrates using a gradient/continuum to receive feedback/rating in accordance with one embodiment. The buttons that are typically used to perform the function of buying goods, and/or adding goods to a shopping cart (of FIG. 9), may be replaced by a feedback-rating/action button. For example, as shown by FIG. 10, button 1010 can be a feedback-rating/action button that allows a user to both add a good to a cart and to provide feedback/rating information at the same time. For example, by clicking on the left portion 1011 of button 1010, a user can indicate a negative rating. By clicking on the right portion 1012 of button 1010, a user can indicate a positive rating. In one embodiment of the present invention, buttons 1010 and 1020 may be multizone buttons. In one embodiment, these multizone buttons may include 3 zones (where the zones correspond to a worse-than-expected rating, a just-fair rating, and a better-than-expected rating, respectively).

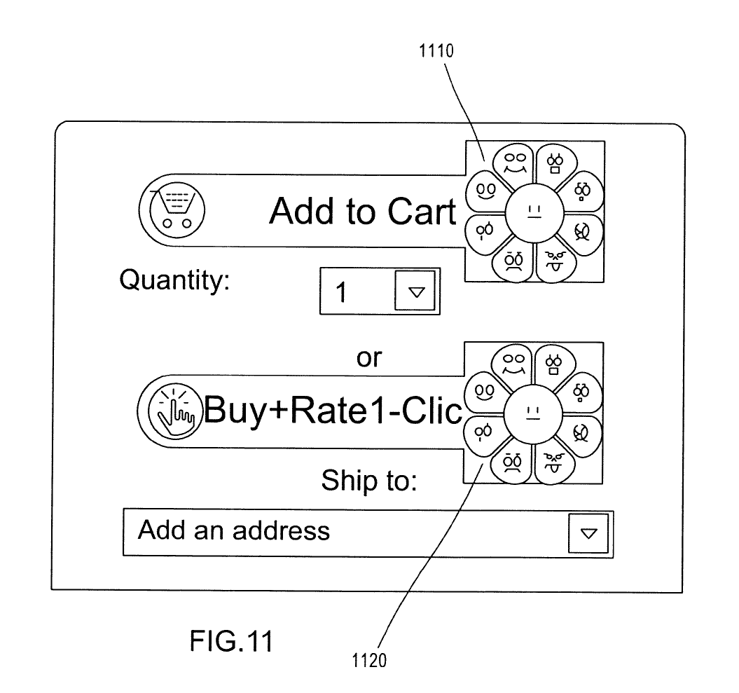

FIG. 11 illustrates using multizone buttons to complete an electronic-commerce transaction in accordance with one embodiment. Similar to the above-described embodiments, each of buttons 1110 and 1120 may be multizone buttons that correspond to emotional-rose buttons.

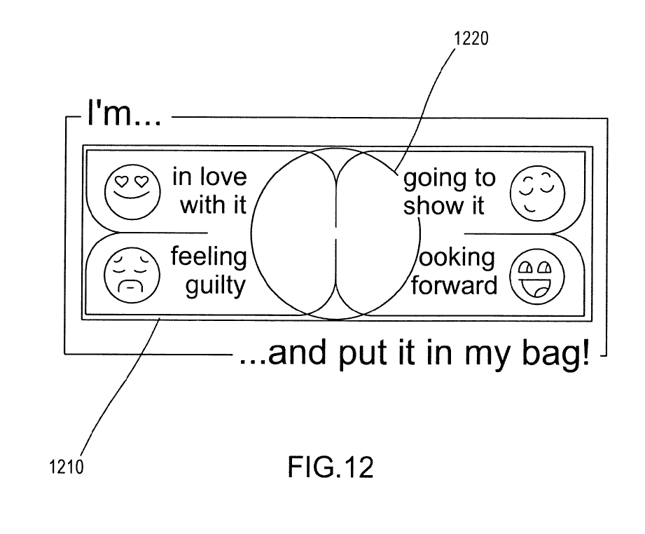

FIG. 12 illustrates a zoned feedback-rating/action button in accordance with one embodiment. The received rating could be directed at the buying/customer experience or the very item being purchased. In one embodiment, a zoned feedback-rating/action button could be provided as shown in FIG. 12. With this zoned feedback-rating/action button, a whole button may be positioned inside a first area 1210. The neutral/no-feedback area could correspond to the area inside a second area 1220. Embodiments of the present invention may combine the concept of using a gradient with the concept of using zones to receive feedback/rating. For example, in one example, the further from a center toward a corner that the user positions the touch point, the stronger the corresponding expressed feeling.

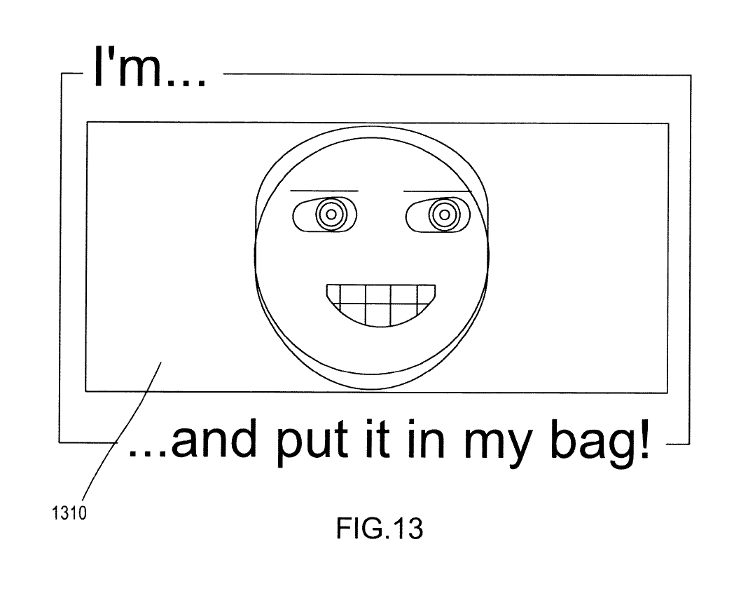

FIG. 13 illustrates a 2-dimensional affective-gradient feedback-rating/action button in accordance with one embodiment. In one embodiment of the present invention, a full 2-dimensional affective-gradient feedback-rating/action button may result from combining an affect pad, like an AffectButton 1310. A touch, a move, or a hovering outside a central neutral zone will display a face that fades into the screen. The face provides cues to the user about the mood that the user is expressing by clicking and/or touching on that point. The face changes to different moods, of different strength, as the user hovers over different areas of the AffectButton 1310.

Although embodiments of the present invention may be computer-implemented, other embodiments of the present invention can also be implemented on physical device, as described in more detail below.

Certain embodiments of the present invention can be used in conjunction with physical devices that are used with shopping venues, services providers, and entertainment venues. Currently, many venues have kiosks and/or totems that are inside a service area to let customers input feedback. Many venues request that the customers perform a process/flow and then provide feedback/rating information at the end of the process/flow. For example, with a typical shopping venue, the venue may request that the user complete a process/flow to complete the sale of a good, and then request the user to complete a survey that rates their experience, for example. However, as described above, typical shopping venues may experience a deficiency of feedback/rating because customers may skip the typically optional step of providing feedback/rating information.

According to embodiments of the present invention, the function of the above-described feedback-rating/action button can be physically implemented, as described in more detail below. In other words, embodiments of the present invention can allow a user to provide a feedback/rating in the course of proceeding through a mandatory path of a process/flow, such that the feedback/rating is provided by the user without adding any new steps and/or delay into the process/flow.

As mentioned above, collecting feedback/rating information from users and customers is desirable. However, according to the previous approaches, users/customers were generally requested to submit feed back through a separate means (such as via a separate website) from a main process/flow. The previous approaches also informed users/customers of methods of providing feedback/ratings via descriptions on cash/point-of-sale tickets. These descriptions may describe a Quick-Response code and/or a website that the customers/users can access. These previous approaches generally require the user to take an extra step beyond the minimum, and the customers/users will generally not offer feedback/ratings information unless they are strongly motivated to do so.

For example, some embodiments of the present invention provide an opportunity for the customer/user to offer feedback/rating information at an exit-point. As such, customers/users can offer feedback when performing the existing steps, which minimizes the hassle for the customers/users. Specifically, certain embodiments of the present invention can be used in conjunction with media shows/events. These shows/events may have large spaces, so there may be several gates that serve as exits. One embodiment of the present invention can designate some gates as corresponding to positive (“thumb-up” ratings), and other gates as corresponding to negative (“thumb-down” ratings). In one embodiment, the gates may be positioned to alternate between each type of gate, so that the attendees can rate the event by just choosing which thumb-up/thumb-down corridor/gate to exit from. Embodiments of the present invention can certainly extend beyond gates. These extensions may add fun, without confusing customers/users.

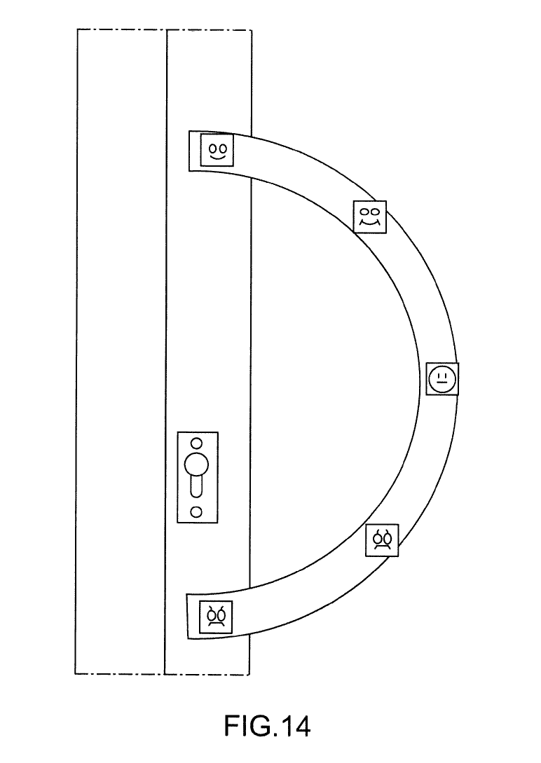

FIG. 14 illustrates a multizone door handle in accordance with one embodiment. In one embodiment, a normal handle for an exit/entry door can be replaced by a multizone door handle to receive feedback/rating information, depending on how the user chooses to contact the door handle. Other variations of implementing a multizone element that receives feedback/rating information can also be used. The feedback/ratings provided by customers/users via the door/gate can be read using sensors. The feedback/ratings may also be read by a camera, which might already be present for other similar purposes.

Although the immediately preceding embodiment places different zones on a door handle, other embodiments may place the zones on other parts of the door/gate. For example, the zones can be placed on the outer surface of the door. Users can then provide their feedback/rating by selecting which zones to push to pass through the door.

Certain embodiments of the present invention can be used in conjunction with any shopping/service transaction that is completed with payment. For example, if payment is performed by a customer/user at a point-of-sale, an <OK> key on a payment device may be replaced by a feedback-rating/action button, as described above.

If a point-of-sale is a virtual point-of-sale that is performed by submitting a mobile payment (via a user's mobile-device application or via a Short-Message-Service from the user's phone), the above-described embodiments relating to electronic commerce can be used.

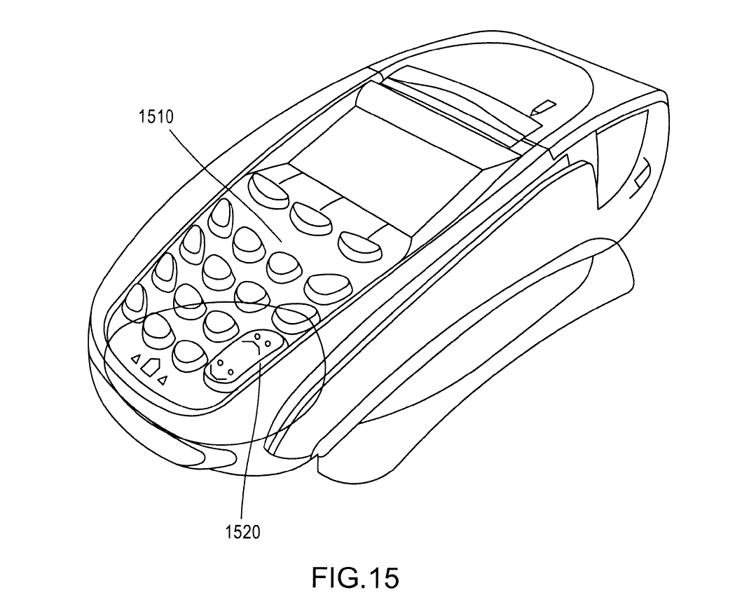

FIG. 15 illustrates implementing a feedback-rating/action button on a point-of-sale device in accordance with one embodiment. One embodiment of the present invention can be implemented at a point-of-sale device. Most point-of-sale devices may be implemented with a hardware keyboard 1510. Thus, a feedback-rating/action button 1520 may be implemented without requiring any costly retrofitting nor any device exchange.

In one embodiment of the present invention, a payment system can be augmented to handle up to two extra optional digits additional to the Personal-Identification-Number code, which allows the user to encode a rating at the same time as entering the PIN number. In one embodiment, a default pre-set could be just one extra digit. The extra digit can be a rating. Additionally, after the user enters a pin number, a lack of any additional number can correspond to “no rating” provided. Entering an additional number of “8” can correspond to a “normal/as-expected” rating, an additional number of “9” an correspond to a “better-than-expected” rating, and an additional number of “7” can correspond to a “worse-than-expected” rating. As such, if a PIN number corresponds to “12345,” and if that the user enters “123457” <OK>, then the user has provided a “7” rating (which corresponds to the “worse-than-expected” rating).

In another embodiment, a first extra digit may be used to define a category for which the feedback/rating is directed to (e.g., “1” may correspond to “service,” “2” may correspond to “environment,” “3” may correspond to “prices,” and “4” may correspond to “personnel,” for example), and a second extra digit may correspond to the actual feedback/rating. Such a configuration may be managed by the user from a suitable website/application.

In another embodiment, the point-of-sale device may correspond to a vending machine of food, drinks, or consumer goods. Each button of the vending machine may correspond to a different selectable food, drink, or consumer good. Similar to the embodiments described above, each button of the vending machine may have a corresponding feedback-rating/action button that allows a user to rate the purchased item or to rate the purchasing experience. As described above, the feedback-rating/action button can be in the form of an emotional rose, a gradient/continuum, an affect pad, or have any other multizone presentation.

Further, if the vending machine includes a keypad for users to uniquely identify an item to purchase, embodiments of the present invention can implement a feedback-rating/action button as described above.

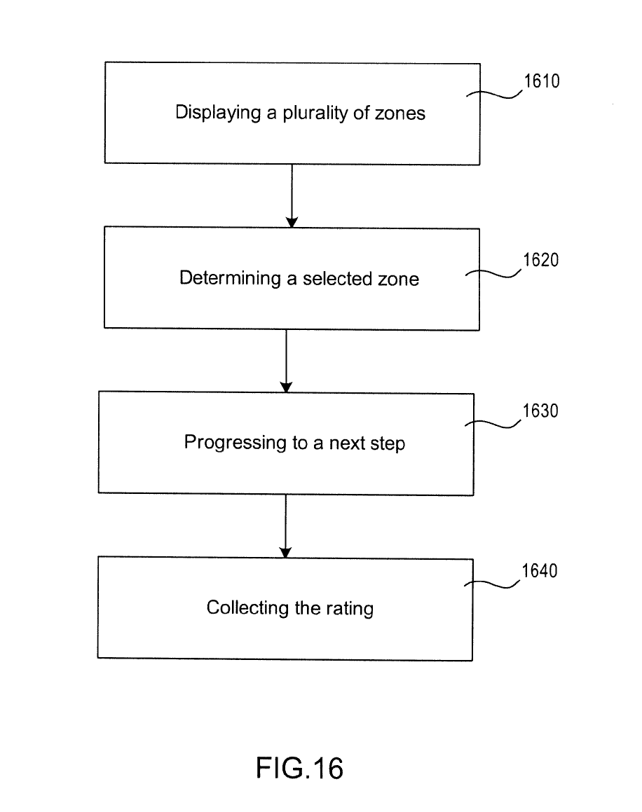

FIG. 16 illustrates a logic flow diagram of a method according to certain embodiments of the invention. The method illustrated in FIG. 16 includes, at 1610, displaying a plurality of zones to a user. The plurality of zones is displayed during a process flow. Each zone of the plurality of zones corresponds to a different rating related to the process flow. The process flow comprises a plurality of steps to progress through. The method also includes, at 1620, determining a selected zone that is selected by the user. The method also includes, at 1630, progressing to a next step of the process flow upon determining the selected zone. The plurality of zones are configured to allow the user to perform a dual action that comprises providing a rating related to the process flow and progressing to the next step of the process flow by performing a singular step of selecting the selected zone. The method also includes collecting the rating provided by the user.

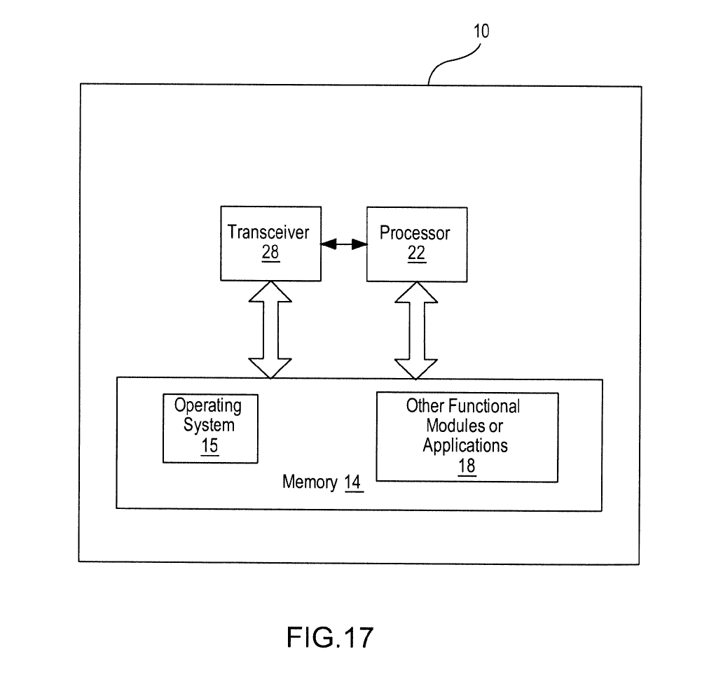

FIG. 17 illustrates an apparatus 10 according to embodiments of the invention. Apparatus 10 can be a computing device that can display a user interface to customers/users, for example.

Apparatus 10 can include a processor 22 for processing information and executing instructions or operations. Processor 22 can be any type of general or specific purpose processor. While a single processor 22 is shown in FIG. 17, multiple processors can be utilized according to other embodiments. Processor 22 can also include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 can further include a memory 14, coupled to processor 22, for storing information and instructions that can be executed by processor 22. Memory 14 can be one or more memories and of any type suitable to the local application environment, and can be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (RAM), read only memory (ROM), static storage such as a magnetic or optical disk, or any other type of non-transitory machine or computer readable media. The instructions stored in memory 14 can include program instructions or computer program code that, when executed by processor 22, enable the apparatus 10 to perform tasks as described herein.

Apparatus 10 can also include one or more antennas (not shown) for transmitting and receiving signals and/or data to and from apparatus 10. Apparatus 10 can further include a transceiver 28 that modulates information on to a carrier waveform for transmission by the antenna(s) and demodulates information received via the antenna(s) for further processing by other elements of apparatus 10. In other embodiments, transceiver 28 can be capable of transmitting and receiving signals or data directly.

Processor 22 can perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In certain embodiments, memory 14 stores software modules that provide functionality when executed by processor 22. The modules can include an operating system 15 that provides operating system functionality for apparatus 10. The memory can also store one or more functional modules 18, such as an application or program, to provide additional functionality for apparatus 10. The components of apparatus 10 can be implemented in hardware, or as any suitable combination of hardware and software.

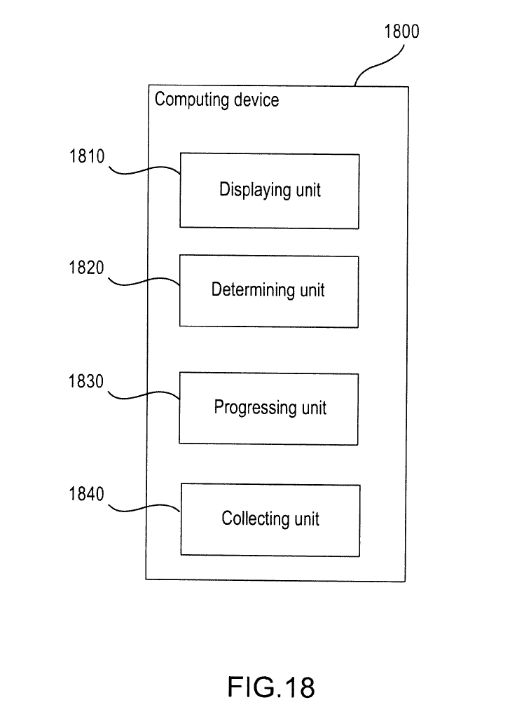

FIG. 18 illustrates an apparatus in accordance with one embodiment. Apparatus 1800 includes a displaying unit 1810 that displays a plurality of zones to a user. The plurality of zones is displayed during a process flow. Each zone of the plurality of zones corresponds to a different rating related to the process flow. The process flow comprises a plurality of steps to progress through. Apparatus 1800 also includes a determining unit 1820 that determines a selected zone that is selected by the user. Apparatus 1800 also includes a progressing unit 1830 that progresses to a next step of the process flow upon determining the selected zone. The plurality of zones are configured to allow the user to perform a dual action that comprises providing a rating related to the process flow and progressing to the next step of the process flow by performing a singular step of selecting the selected zone. Apparatus 1800 also includes a collecting unit 1840 that collects the rating provided by the user.

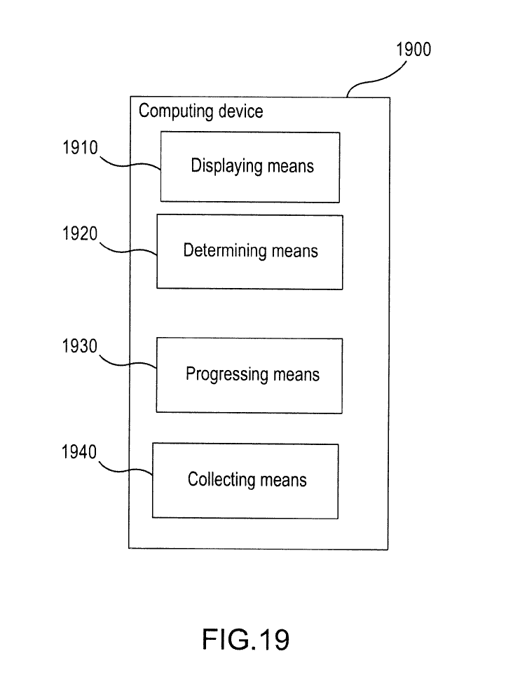

FIG. 19 illustrates an apparatus in accordance with one embodiment. The apparatus 1900 includes a displaying means 1910 for displaying a plurality of zones to a user. The plurality of zones is displayed during a process flow. Each zone of the plurality of zones corresponds to a different rating related to the process flow. The process flow comprises a plurality of steps to progress through. Apparatus 1900 also includes a determining means 1920 that determines a selected zone that is selected by the user. Apparatus 1900 also includes a progressing means 1930 that progresses to a next step of the process flow upon determining the selected zone. The plurality of zones are configured to allow the user to perform a dual action that comprises providing a rating related to the process flow and progressing to the next step of the process flow by performing a singular step of selecting the selected zone. Apparatus 1900 also includes a collecting means 1940 that collects the rating provided by the user.

The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1-9. (canceled)

10. An apparatus, comprising:
at least one processor; and
at least one memory including computer program code,
the at least one memory and the computer program code configured, with the at least one processor, to cause the apparatus at least to display a plurality of zones to a user, wherein the plurality of zones is displayed during a process flow, wherein each zone of the plurality of zones corresponds to a different rating related to the process flow, and the process flow comprises a plurality of steps to progress through;
determine a selected zone that is selected by the user;
progress to a next step of the process flow upon determining the selected zone, wherein the plurality of zones are configured to allow the user to perform a dual action that comprises providing a rating related to the process flow and progressing to the next step of the process flow by performing a singular step of selecting the selected zone; and
collect the rating provided by the user.

11. The apparatus according to claim 10, wherein the displaying the plurality of zones comprises displaying a multizone button, and a portion of the multizone button corresponds to a neutral rating or does not correspond to any rating.

12. The apparatus according to claim 10, wherein the displaying the plurality of zones comprises displaying an emotional-rose button.

13. The apparatus according to claim 11, wherein the displaying the multizone button comprises displaying a multizone button that functions as a navigation button, and the navigation button navigates through displayed content.

14. The apparatus according to claim 10, wherein the displaying the plurality of zones comprises displaying the plurality of zones on different portions of a door.

15. The apparatus according to claim 10, wherein the displaying the plurality of zones comprises displaying the plurality of zones on a keypad of a point-of-sale device.

16. The apparatus according to claim 10, wherein the displaying the plurality of zones comprises providing a plurality of gates, and each zone of the plurality of zones corresponds to a gate of the plurality of gates, and the determining the selected zone that is selected by the user comprises determining which gate the user moves through.

17. The apparatus according to claim 10, wherein the displaying the plurality of zones comprises displaying the zones on a vending machine, and the collecting the rating comprises collecting a rating of a purchasing experience with the vending machine or a rating of a product purchased from the vending machine.

18. The apparatus according to claim 10, wherein the displaying the plurality of zones to the user comprises displaying the zones as at least one of a gradient or an affect pad.

19. A non-transitory computer readable medium having instructions stored thereon, the instructions configured to control a processor to perform a process, comprising:
displaying a plurality of zones to a user, wherein the plurality of zones is displayed during a process flow, wherein each zone of the plurality of zones corresponds to a different rating related to the process flow, and the process flow comprises a plurality of steps to progress through;
determining a selected zone that is selected by the user;
progressing to a next step of the process flow upon determining the selected zone, wherein the plurality of zones are configured to allow the user to perform a dual action that comprises providing a rating related to the process flow and progressing to the next step of the process flow by performing a singular step of selecting the selected zone; and
collecting the rating provided by the user.

20. The computer readable medium according to claim 19, wherein the displaying the plurality of zones comprises displaying a multizone button, and a portion of the multizone button corresponds to a neutral rating or does not correspond to any rating.

21. The computer readable medium according to claim 19, wherein the displaying the plurality of zones comprises displaying an emotional-rose button.

22. The computer readable medium according to claim 20, wherein the displaying the multizone button comprises displaying a multizone button that functions as a navigation button, and the navigation button navigates through displayed content.

23. The computer readable medium according to claim 19, wherein the displaying the plurality of zones comprises displaying the plurality of zones on different portions of a door.

24. The computer readable medium according to claim 19, wherein the displaying the plurality of zones comprises displaying the plurality of zones on a keypad of a point-of-sale device.

25. The computer readable medium according to claim 19, wherein the displaying the plurality of zones comprises providing a plurality of gates, and each zone of the plurality of zones corresponds to a gate of the plurality of gates, and the determining the selected zone that is selected by the user comprises determining which gate the user moves through.

26. The computer readable medium according to claim 19, wherein the displaying the plurality of zones comprises displaying the zones on a vending machine, and the collecting the rating comprises collecting a rating of a purchasing experience with the vending machine or a rating of a product purchased from the vending machine.

27. The computer readable medium according to claim 19, wherein the displaying the plurality of zones to the user comprises displaying the zones as at least one of a gradient or an affect pad.

28. A method, comprising:
displaying a plurality of zones to a user, wherein the plurality of zones is displayed during a process flow, wherein each zone of the plurality of zones corresponds to a different rating related to the process flow, and the process flow comprises a plurality of steps to progress through;
determining a selected zone that is selected by the user;
progressing to a next step of the process flow upon determining the selected zone, wherein the plurality of zones are configured to allow the user to perform a dual action that comprises providing a rating related to the process flow and progressing to the next step of the process flow by performing a singular step of selecting the selected zone; and
collecting the rating provided by the user.
